(19) United States
(12) Patent Application Publication
(10) Pub. No.: US 2014/0122221 A1
(43) Pub. Date: May 1, 2014

(54) OPTIMIZING BIDDING WITH MULTIPLE CAMPAIGN TYPES

(71) Applicants: John Stattler, (US); John Stattler, (US); John Stattler, (US); YAHOO! INC., Sunnyvale, CA (US)

(72) Inventors: Patrick Jordan, Mountain View, CA (US); Prabhakar Krishnamurthy, Pleasanton, CA (US); Sergei Vassilvitskii, New York, NY (US); Mohammad Mahdian, Santa Clara, CA (US)

(73) Assignee: YAHOO! INC., Sunnyvale, CA (US)

(21) Appl. No.: 13/664,088

(22) Filed: Oct. 30, 2012

(51) Int. Cl. G06Q 30/02

(52) U.S. Cl. 705/14.43

(57) ABSTRACT

A method, system, and computer program product for optimizing bidding over multiple advertising campaigns having a least two campaign types. The optimization is subjected to at least one constraint quantifying a multiple campaign spending limit amount. The method commences by identifying a collection of the multiple advertising campaigns, then evaluating each of the constituent member advertising campaigns to determine its respective optimized spending amount. Then the method calculates (e.g., sums) an aggregate spending amount by aggregating the individual campaign spending amounts. When the aggregate spending amount is greater than the multiple campaign constraint, then the method apportions the multiple campaign spending limit amount to the constituent member advertising campaigns which is in turn used to determine a reduced spending limit. The time period under which the spending is optimized can be any time period suited for forming bids to bid on inventory of impressions into which advertisements can be placed.

### FIELD

The present disclosure is directed towards internet advertising, more particularly to optimizing bidding with multiple campaign types during prosecution of advertising campaigns.

### BACKGROUND

Advertisers may run multiple campaigns as part of their marketing strategy. The objectives of each of these campaigns may differ. For instance, some campaigns may have branding goals, whereas others may have specific quantitative performance goals. In addition, the advertisers may specify budgets over sets of campaigns. For the purposes of optimizing the campaign spend relative to campaign budgets, this presents a difficult multi-objective optimization problem. Legacy systems fail to optimize in multi-campaign/multi-objective optimization situations, thus what is needed are methods for jointly optimizing advertising campaigns over disparate objectives given a total budget constraint covering a set of campaigns while still observing individual campaign budget constraints.

Other features and advantages will be apparent from the accompanying drawings, and from the detailed description that follows below.

### SUMMARY

Disclosed herein are computer implemented methods, and systems for optimizing bidding over multiple advertising campaigns having a least two campaign types. The optimization of the multiple advertising campaigns is performed subject to at least one constraint quantifying a multiple campaign spending limit amount.

The method commences by identifying a collection of the multiple advertising campaigns, where each constituent member advertising campaign has at least a respective optimization function and a respective spending limit amount. Then, the method proceeds by evaluating each of the constituent member advertising campaigns to determine a respective optimized spending amount (for that constituent member advertising campaign). The optimized spending amount is determined using the respective optimization function.

Once all of the constituent member advertising campaigns have been evaluated, then the method calculates (e.g., sums) an aggregate spending amount by aggregating the respective optimized spending amount across the constituent member advertising campaigns. A Pareto-optimal allocation is determined as follows:
when the aggregate spending amount is less than or equal to the multiple campaign spending limit amount, then spending the respective optimized spending amount in the constituent member advertising campaigns (since the constraint of the multiple campaign spending limit amount is not violated);
when the aggregate spending amount is greater than the multiple campaign spending limit amount, then apportioning the multiple campaign spending limit amount to the constituent member advertising campaigns to determine a reduced spending limit used in calculating an optimized spending amount in the constituent member advertising campaigns.

The time period under which the spending is optimized can be weeks or days, or any convenient time suited for forming bids to bid on available inventory of advertising impressions that can be monetized (e.g., by placing an advertisement).

### BRIEF DESCRIPTION OF THE DRAWINGS

The novel features are set forth in the appended claims. However, for purpose of explanation, several embodiments are set forth in the following figures.

FIG. 1 is a flow diagram depicting a processing flow used for optimizing bidding with multiple campaign types, according to some embodiments.

FIG. 2 depicts an environment for optimizing bidding with multiple campaign types, according to some embodiments.

FIG. 3 depicts a form for optimizing bidding in a branding campaign, according to some embodiments.

FIG. 4 depicts a form for optimizing bidding in a performance-driven campaign, according to some embodiments.

FIG. 5 depicts a form for optimizing bidding with multiple campaign types, according to some embodiments.

FIG. 6 depicts a data layout for optimizing bidding with multiple campaign types, according to some embodiments.

FIG. 7 depicts a flow chart for optimizing bidding with multiple campaign types, according to some embodiments.

FIG. 8 depicts a system for optimizing bidding with multiple campaign types, according to some embodiments.

FIG. 9 depicts a schematic diagram illustrating an example embodiment of an advertising network for optimizing bidding with multiple campaign types, according to some embodiments.

FIG. 10 depicts a schematic diagram illustrating an example embodiment of a client device for optimizing bidding with multiple campaign types, according to some embodiments.

FIG. 11 is a block diagram of a computer system for implementing embodiments.

Like reference characters refer to corresponding parts throughout the drawings.

### DETAILED DESCRIPTION

In modern advertising systems, advertisers may elect to prosecute multiple advertising campaigns as part of their overall marketing and advertising strategy. The objectives of each of these campaigns may differ. For instance, some campaigns may have branding goals (e.g., maximize impressions), whereas others may have specific quantitative performance goals (e.g. total return on investment for a given budget, etc.). In addition to specifying goals and constraints, the advertisers may specify budgets over sets of campaigns. Optimizing a total, multi-campaign budget relative to individual campaign budgets presents a difficult multi-objective optimization problem. What is needed are methods for optimizing advertising campaigns over disparate objectives given a total budget constraint covering a set of campaigns while still observing individual campaign budget constraints.

Herein-described are techniques that heuristically determine the remaining spend (e.g. advertising budget) apportioned to each campaign from among a collection of advertising campaigns. The heuristics observe both individual campaign budget constraints as well as a multi-campaign budget over all the constituent campaigns within the collection. The techniques consider a set of possible campaign objectives, each campaign having one or more constraints against which an optimizer seeks to optimize for a particular objective result. For example, a particular objective result might be to maximize the number of clicks, or to maximize a click-through rate. Or, a particular objective result might be to maximize the return on investment (e.g. return on advertising budget spent). Or a particular objective result might be to optimize the representativeness of the allocation won, etc. In some cases, calculating and adhering to or performing to the optimized variables during a time period in an effort to achieve a particular objective result might in an optimized spending amount for that time period. Of course it is possible that in a given time period, it is not feasible to perform to the optimized variables. For example, an optimal calculation might indicate a particular spending amount (e.g. to place some optimal number of advertisements), but such an optimal calculation might be infeasible to perform when, for example, there is not enough inventory (e.g. ad calls) in which to place the optimal number of advertisements.

In exemplary embodiments, for each individual campaign, the individual campaign has a particular quantitative objective, and for each quantitative objective there is an algorithm (e.g. a function, a subroutine, a method, etc.) that serves to calculate an optimal bid given a budget constraint and possibly other constraints as well. Of course, it follows that once spent, a bid that is optimal for one individual campaign will reduce the overall budget for the collection of advertising campaigns. Moreover, it might be possible that the same amount of spend applied to achieve a particular quantitative objective in one individual campaign might be more effective to achieve using a different quantitative objective in a different campaign within the same collection of advertising campaigns. Therefore, techniques are needed so as to calculate an optimal set of bids across multiple campaigns given the multiplicity of objectives and the multiplicity of campaign constraints and given a multi-campaign budget constraint (e.g. a multiple-campaign spending limit amount).

Of course, a campaign is conducted during some particular time period, and that time period is used by the aforementioned objective functions and by the optimizers discussed herein. Similarly, a campaign that is conducted during some particular time period has a spending limit covering the respective time period. For example, a particular advertising campaign might have a “daily limit” of some particular amount. Or, for example, a particular advertising campaign might have a “monthly limit” of some particular amount.

### Two-Phase Optimizer

Some embodiments use two passes. Strictly as an example, a two-phase optimizer might commence a first phase in which each individual campaign from among the collection of individual advertising campaigns is considered separately, and the optimal bids and resulting spend for each individual campaign among the collection of advertising campaigns is calculated considering the respective individual campaign budget and respective individual campaign objectives, and using the respective objective function of each respective individual campaign.

In a second phase, the resulting aggregate spending (e.g. sum of spending of each respective individual campaign) is compared to see if the calculated aggregate spending exceeds a multi-campaign budget. If not, the technique uses the optimal bid policies for each campaign as calculated in the first phase. However, if the calculated aggregate spending does exceed the multi-campaign budget, then a processor will apportion to each campaign a fraction of the multi-campaign budget.

In one embodiment, the fraction of the multi-campaign budget apportioned to the respective campaigns is in proportion to the contribution (e.g. percentage) of each respective campaign to the aggregate resulting spend. Other apportioning (e.g. non-linear apportioning) is reasonable and envisioned, including apportioning based on advertiser-specified importance of one campaign or another (e.g. a branding campaign versus a search-term campaign, etc.), or based on advertiser-specified importance of one campaign variable or another (e.g. a total impressions presented versus return on investment, etc.). Given the apportioned individual campaign budgets (e.g. as apportioned according to the aforementioned techniques), it is possible to calculate the optimal bid for each individual campaign using the respective function or subroutine or other individual campaign optimizer (e.g. the results of which campaign optimizer are determined by the campaign objectives and constraints). Having apportioned fractions of the multi-campaign budget to the individual budgets of the individual campaigns, then each individual campaign is optimized (using the apportioned fractions of the multi-campaign budget) and the bid policies for each individual campaign are calculated and spent, accordingly.

Note that the spending constraints for any individual campaign is observed. As well, the spending constraints for the multi-campaign (e.g. a multi-campaign budget) is also observed.

An algorithmic description of the above two-phase solution is given in Algorithm 1, below.

Algorithm 1: GenerateBidPolicies

```
  input : C - set of campaigns,
        {B_{c}}_{eεC} - the set of individual campaign budgets
        M - the aggregate budget over all campaigns
        Optimize- the optimization subroutine
  output: {π_{c}}_{cεC} - the set of individual campaign bidding policies
  // First phase
1 foreach c ε C do
  | // Determine each campaigns bid policy and spend,
  | // given only the individual campaign budget.
2  |_π_{c},s_{c} ←Optimize(c,B_{c})
  // Determine the aggregate spend
3 s← Σ_{cεC} s_{c}
  // Second phase
4 if s > M then
5  | foreach c ε C do
  | | // Determine each campaign's proportion
  | | // of the aggregate budget
6  | | w_{c} ← s_{c}/s
  | | // Re-optimize
7  | |_ π_{c} ←Optimize(c,w_{c}M)
  |_{—}
8 return {π_{c}}_{cεC}
```

Note that the allocations made in accordance with Algorithm 1 are Pareto-optimal. Algorithm 1 might be implemented in an advertising network, using one or more computers.

Reference will now be made in detail to various embodiments, some examples of which are illustrated in the accompanying drawings. It will be understood that the described embodiments are not intended to limit the scope of the claims. On the contrary, the embodiments are intended to cover alternatives, modifications and equivalents, which may be included within the scope of the appended claims. Furthermore, in the following detailed descriptions, numerous specific details are set forth in order to provide a thorough understanding of the exemplary embodiments. However, one of ordinary skill in the art can recognize that the present advances may be practiced without these specific details. In other instances, well known methods, procedures, components, and circuits have not been described in detail so as avoid unnecessarily obscuring aspects of the described embodiments.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms such as “and”, “or”, or “and/or” as used herein may include a variety of meanings that may depend at least in part upon the context in which such terms are used. Typically, “or” if used to associate a list; for example, a list such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms such as “a,” “an,” or “the” may be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, depending at least in part on context.

Some portions of the detailed descriptions which follow are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer executed step, logic block, process, etc. as may be used herein is generally conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions using terms such as “processing” or “computing” or “communicating” or “instantiating” or “registering” or “selecting”, or “displaying” or the like, refer to the action and processes of a computer system or similar electronic computing device that manipulates and transforms data represented as physical (electronic) quantities within the computer system's registers and memories into other data similarly represented as physical quantities within the computer system memories or registers or other such information storage, transmission or display devices.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

### Section I: General Terms

Some of the terms used in this description are defined below (in alphabetical order) for easy reference. These terms are not rigidly restricted to these definitions. A term may be further defined by the term's use in other sections of this description.

“Ad” (e.g. ad, item and/or message) means a paid announcement, as of goods or services for sale, preferably on a network such as the internet. An ad may also be referred to as an item and/or a message.

“Ad call” means a message sent by a computer to an ad server for requesting an ad to be displayed.

“Ad click-through rate” (e.g. click-through rate) means a measurement of ad clicks per a period of time.

“Advertiser” (e.g. messenger and/or messaging customer, etc.) means an entity that is in the business of marketing a product and/or a service to users. An advertiser may include, without limitation, a seller and/or a third-party agent for the seller. An advertiser may also be referred to as a messenger and/or a messaging customer. Advertising may also be referred to as messaging.

“Advertising” means marketing a product and/or service to one or more potential consumers by using an ad. One example of advertising is publishing a sponsored search ad on a website.

“Ad targeting” or “targeting” refers to web portals like Yahoo!, where advertisements may be displayed on web pages resulting from a user-defined search based at least in part upon one or more search terms. Advertising may be beneficial to users, advertisers or web portals if displayed advertisements are relevant to interests of one or more users. Thus, a variety of techniques have been developed to infer user interest, user intent or to subsequently target relevant advertising to users. One approach to presenting targeted advertisements includes employing demographic characteristics (e.g. age, income, sex, occupation, etc.) for predicting user behavior, such as by group. Advertisements may be presented to users in a targeted audience based at least in part upon predicted user behavior(s). Another approach includes profile-type ad targeting. In this approach, user profiles specific to a user may be generated to model user behavior, for example, by tracking a user's path through a web site or network of sites, and compiling a profile based at least in part on pages or advertisements ultimately delivered. A correlation may be identified, such as for user purchases, for example. An identified correlation may be used to target potential purchasers by targeting content or advertisements to particular users.

“Application server” is a server that is configured for running one or more devices loaded on the application server. For example, an application server may run a device configured for deducing shadow profiles.

“Click” (e.g. ad click) means a selection of an ad impression by using a selection device such as, for example, a computer mouse or a touch-sensitive display.

“Client” means the client part of a client-server architecture. A client is typically a user device and/or an application that runs on a user device. A client typically relies on a server to perform some operations. For example, an email client is an application that enables a user to send and receive email via an email server. In this example, the computer running such an email client may also be referred to as a client.

A “Computing device” means a computing device that may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

A “Content server” is a server that may include a device that includes a configuration to provide content via a network to another device. A content server may, for example, host a site, such as a social networking site, examples of which may include, without limitation, Flicker, Twitter, Facebook, LinkedIn, or a personal user site (such as a blog, vlog, online dating site, etc.). A content server may also host a variety of other sites, including, but not limited to business sites, educational sites, dictionary sites, encyclopedia sites, wikis, financial sites, government sites, etc.

A content server may further provide a variety of services that include, but are not limited to, web services, third-party services, audio services, video services, email services, instant messaging (IM) services, SMS services, MMS services, FTP services, voice over IP (VOIP) services, calendaring services, photo services, or the like. Examples of content may include text, images, audio, video, or the like, which may be processed in the form of physical signals, such as electrical signals, for example, or may be stored in memory, as physical states, for example.

Examples of devices that may operate as a content server include desktop computers, multiprocessor systems, microprocessor-type or programmable consumer electronics, etc.

“Conversion” (e.g. ad conversion) means a purchase of a product/service that happens as a result of a user responding to an ad and/or a coupon.

A “Content delivery network” or “Content distribution network” (CDN) or “base content server” refers to a distributed content delivery system that comprises a collection of computers or computing devices linked by a network or networks. A CDN may employ software, systems, protocols or techniques to facilitate various services, such as storage, caching, communication of content, or streaming media or applications. Services may also make use of ancillary technologies including, but not limited to, “cloud computing,” distributed storage, DNS request handling, provisioning, signal monitoring and reporting, content targeting, personalization, or business intelligence. A CDN may also enable an entity to operate or manage another's site infrastructure, in whole or in part.

“Database” (e.g. database system, etc.) means a collection of data organized in such a way that a computer program may quickly select desired pieces of the data. A database is an electronic filing system. In some instances, the term “database” is used as shorthand for a “database management system”. A database may be implemented as any type of data storage structure capable of providing for the retrieval and storage of a variety of data types. For instance, a database may comprise one or more accessible memory structures such as a CD-ROM, tape, digital storage library, flash drive, floppy disk, optical disk, magnetic-optical disk, erasable programmable read-only memory (EPROM), random access memory (RAM), magnetic or optical cards, etc.

“Device” means hardware, software or a combination thereof. A device may sometimes be referred to as an apparatus. Examples of a device include, without limitation, a software application such as Microsoft Word™ or a database; or hardware such as a laptop computer, a server, a display; or a computer mouse and/or a hard disk.

“Impression” (e.g. ad impression) means a delivery of an ad to a user device for viewing by a user.

The “Internet” refers to a decentralized global network of networks. The Internet includes local area networks (LANs), wide area networks (WANs), wireless networks, or long haul public networks that, for example, allow signal packets to be communicated between LANs. Signal packets may be communicated between nodes of a network, such as, for example, to one or more sites employing a local network address. A signal packet may, for example, be communicated over the Internet from a user site via an access node coupled to the Internet. Likewise, a signal packet may be forwarded via network nodes to a target site coupled to the network via a network access node, for example. A signal packet communicated via the Internet may, for example, be routed via a path of gateways, servers, etc. that may route the signal packet in accordance with a target address and availability of a network path to the target address.

“Monetization techniques” or “Monetization models” refers to techniques used in connection with sponsored search advertising, including advertising associated with user search queries, or non-sponsored search advertising, including graphical or display advertising. In an auction-type online advertising marketplace, advertisers may bid in connection with placement of advertisements, although other factors may also be included in determining advertisement selection or ranking. Bids may be associated with amounts advertisers pay for certain specified occurrences, such as for placed or clicked-on advertisements, for example. Advertiser payment for online advertising may be divided between parties including one or more publishers or publisher networks, one or more marketplace facilitators or providers, or potentially among other parties.

Some models may include guaranteed delivery advertising, in which advertisers may pay based at least in part on an agreement guaranteeing or providing some measure of assurance that the advertiser will receive a certain agreed upon amount of suitable advertising, or non-guaranteed delivery advertising, which may include individual serving opportunities or spot market(s), for example. In various models, advertisers may pay based at least in part on any of various metrics associated with advertisement delivery or performance, or associated with measurement or approximation of particular advertiser goal(s). For example, models may include, among other things, payment based at least in part on cost per impression or number of impressions, cost per click or number of clicks, cost per action for some specified action(s), cost per conversion or purchase, or cost based at least in part on some combination of metrics, which may include online or offline metrics, for example. A process of buying or selling online advertisements may involve a number of different entities, including advertisers, publishers, agencies, networks, or developers. To simplify this process, organization systems called “ad exchanges” may associate advertisers or publishers, such as via a platform to facilitate buying or selling of online advertisement inventory from multiple ad networks. “Ad networks” refers to aggregation of ad space supply from publishers, such as for provision en masse to advertisers.

“Network” means a connection, between any two or more computers, that permits the transmission of data. A network may be any combination of networks including, without limitation, the internet, a local area network, a wide area network, a wireless network, and/or a cellular network.

A “Network” means a network that may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, or any combination thereof. Likewise, sub-networks, such as may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

A wireless network may couple client devices with a network. A wireless network may employ stand-alone ad-hoc networks, mesh networks, Wireless LAN (WLAN) networks, cellular networks, or the like. A wireless network may further include a system of terminals, gateways, routers, or the like coupled by wireless radio links, or the like, which may move freely, randomly or organize themselves arbitrarily, such that network topology may change, at times even rapidly. A wireless network may further employ a plurality of network access technologies, including Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example.

For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

Signal packets communicated via a network, such as a network of participating digital communication networks, may be compatible with or compliant with one or more protocols. Signaling formats or protocols employed may include, for example, TCP/IP, UDP, DECnet, NetBEUI, IPX, Appletalk, or the like. Versions of the Internet Protocol (IP) may include IPv4 or IPv6.

“Publisher” means an entity that publishes, on a network, a web page having content and/or ads, etc. ad/or publishes, on a network, a downloadable application and/or other digital context having digital content and/or digital ads, etc.

“Server” means a software application that provides services to other computer programs (and their users) on the same computer or on another computer or computers. A server may also refer to the physical computer that has been set aside to run a specific server application. For example, when the software Apache HTTP Server is used as the web server for a company's website, the computer running Apache may also be called the web server. Server applications may be divided among server computers over an extreme range, depending upon the workload. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

“Social network” or “social networking website” refers generally to a network of individuals, such as acquaintances, friends, family, colleagues, or co-workers, coupled via a communications network or via a variety of sub-networks. Potentially, additional relationships may subsequently be formed as a result of social interaction via the communications network or sub-networks. A social network may be employed, for example, to identify additional connections for a variety of activities, including, but not limited to, dating, job networking, receiving or providing service referrals, content sharing, creating new associations, maintaining existing associations, identifying potential activity partners, performing or supporting commercial transactions, or the like.

A social network may include individuals with similar experiences, opinions, education levels or backgrounds. Subgroups may exist or be generated according to user profiles of individuals, for example, in which a subgroup member may belong to multiple subgroups. An individual may also have multiple “1:few” associations within a social network, such as for family, college classmates, or co-workers.

An individual's social network may refer to a set of direct personal relationships or a set of indirect personal relationships. A direct personal relationship refers to a relationship for an individual in which communications may be individual to individual, such as with family members, friends, colleagues, co-workers, or the like. An indirect personal relationship refers to a relationship that may be available to an individual with another individual although no form of individual to individual communication may have taken place, such as a friend of a friend, or the like. Different privileges or permissions may be associated with relationships in a social network. A social network also may generate relationships or connections with entities other than a person, such as companies, brands, or so-called ‘virtual persons.’ An individual's social network may be represented in a variety of forms, such as visually, electronically or functionally. For example, a “social graph” or “socio-gram” may represent an entity in a social network as a node and a relationship as an edge or a link.

Individuals within one or more social networks may interact or communication with other members of a social network via a variety of devices. Multi-modal communication technologies refers to a set of technologies that permit interoperable communication across multiple devices or platforms, such as cell phones, smart phones, tablet computing devices, personal computers, televisions, SMS/MMS, email, instant messenger clients, forums, social networking sites (such as Facebook, Twitter, or Google+), or the like.

“Software” means a computer program that is written in a programming language that may be used by one of ordinary skill in the art. The programming language chosen should be compatible with the computer on which the software application is to be executed and, in particular, with the operating system of that computer. Examples of suitable programming languages include, without limitation, Object Pascal, C, C++ and/or Java. Further, the functions of some embodiments, when described as a series of steps for a method, could be implemented as a series of software instructions for being operated by a processor such that the embodiments could be implemented as software, hardware, or a combination thereof. Computer-readable media are discussed in more detail in a separate section below.

“System” means a device or multiple coupled devices. A device is defined above.

“User” (e.g. consumer, etc.) means an operator of a user device. A user is typically a person who seeks to acquire a product and/or service. For example, a user may be a woman who is browsing Yahoo!™ Shopping for a new cell phone to replace her current cell phone. The term “user” may also refer to a user device, depending on the context.

“User device” (e.g. computer, user computer, client and/or server, etc.) means a single computer or a network of interacting computers. A user device is a computer that a user may use to communicate with other devices over a network, such as the internet. A user device is a combination of a hardware system, a software operating system, and perhaps one or more software application programs. Examples of a user device include, without limitation, a laptop computer, a palmtop computer, a smart phone, a cell phone, a mobile phone, an IBM-type personal computer (PC) having an operating system such as Microsoft Windows™, an Apple™ computer having an operating system such as MAC-OS, hardware having a JAVA-OS operating system, and/or a Sun Microsystems™ workstation having a UNIX operating system.

“Web browser” means a software program that may display text or graphics or both, from web pages on websites. Examples of a web browser include, without limitation, Mozilla Firefox™ and Microsoft Internet Explorer™.

“Web page” means documents written in a mark-up language including, without limitation, HTML (hypertext mark-up language), VRML (virtual reality modeling language), dynamic HTML, XML (extensible mark-up language), and/or other related computer languages. A web page may also refer to a collection of such documents reachable through one specific internet address and/or through one specific website. A web page may also refer to any document obtainable through a particular URL (uniform resource locator).

“Web server” is a server configured for serving at least one web page to a web browser. An example of a web server is a Yahoo!™ web server. A server is defined above.

### Section II: Descriptions of the Figures

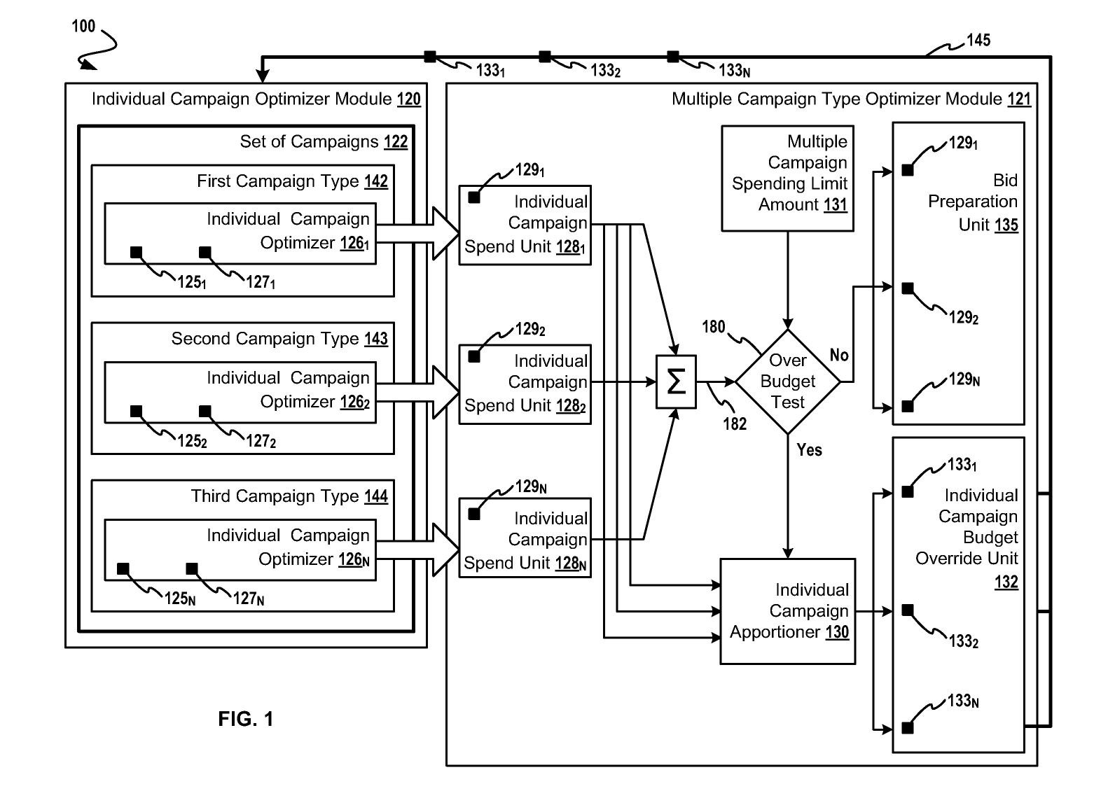

FIG. 1 is a flow diagram depicting a processing flow used for optimizing bidding with multiple campaign types, according to some embodiments. As an option, the present flow diagram 100 may be implemented in the context of the architecture and functionality of the embodiments described herein. Of course, however, the flow diagram or any operation therein may be carried out in any desired environment.

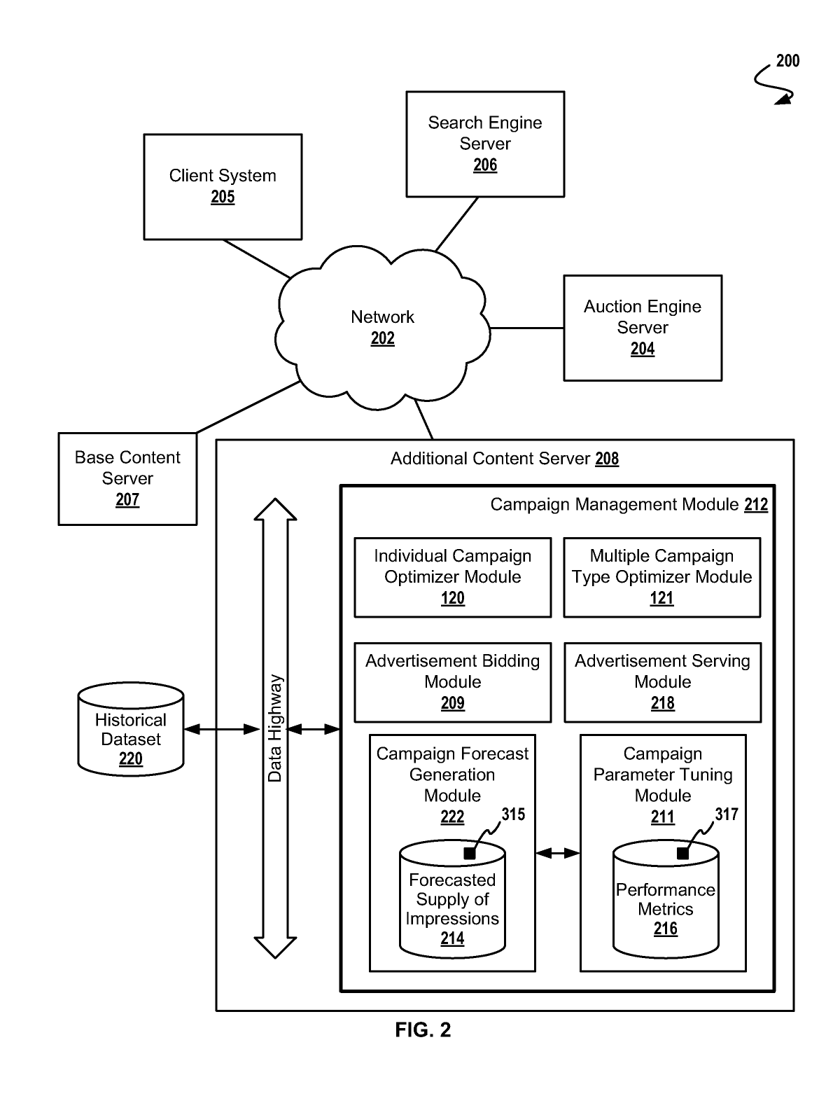

Again referring to Algorithm 1, the system implements a two-phase approach to multi-type campaign optimization. As shown, the system of FIG. 1 is a component within an environment for optimizing bidding (see FIG. 2). The flow diagram depicts data flow within a system for optimizing bidding in the face of a collection of multiple, mixed-type advertising campaigns having a least two campaign types. Optimized bidding is to be performed for the collection given constraints in the individual campaigns as well as a constraint specifying a multiple campaign spending limit amount.

The system operates on an identified collection of multiple advertising campaigns (e.g. set of campaigns 122, as shown). In exemplary embodiments, the set of campaigns comprises constituent member advertising campaigns including at least two campaign types (e.g. selected from among the first type campaign 142, the second type campaign 143, and the third type campaign 144). Each constituent member advertising campaign has a respective individual campaign optimizer (e.g. embodied within an individual campaign optimizer 126₁, individual campaign optimizer 126₂, individual campaign optimizer 126_{N}, etc.) and a constituent member advertising campaign has a respective budget (e.g. individual campaign budget 125₁, individual campaign budget 125₂, individual campaign budget 125_{N}). Similarly, each constituent member advertising campaign has a respective objective function (e.g. individual campaign optimization function 127₁, individual campaign optimization function 127₂, individual campaign optimization function 127_{N}).

In a first phase, the system of FIG. 1 evaluates each constituent member advertising campaign (e.g. using an individual campaign objective function) to determine a respective optimized individual campaign spend amount, while observing the respective individual campaign budget. Such first phase operations might be performed within an individual campaign optimizer module 120, which module serves to optimize any individual campaign, and results in a respective optimized spending amount (e.g. optimized individual campaign spend 129₁, optimized individual campaign spend 129₂, optimized individual campaign spend 129_{N}, etc.) for each campaign. In some embodiments, an optimized individual campaign spend might be stored and operated upon by an individual campaign spend unit (e.g. individual campaign spend unit 128₁, individual campaign spend unit 128₂, individual campaign spend unit 128_{N}, etc.). In some embodiments, there are a large number of individual campaign spend units, and any one individual campaign spend unit might be geographically distant from another individual campaign spend unit, as might be the case in a global campaign. In some cases an individual campaign spend unit might perform processing to handle special cases, such as exceptions, or situations when the optimized spending amount for a campaign is infeasible to spend (e.g. due to lack of available inventory, for example).

In a second phase, the system of FIG. 1 calculates an aggregate spending amount by aggregating the individual optimized spending amounts across the constituent member advertising campaigns, and then determines an amount to spend by processing differently based on certain conditions. Such second phase operations might be performed within a multiple campaign type optimizer module 121, which module serves to optimize multiple campaigns.

The multiple campaign type optimizer module 121 aggregates or sums (e.g. using the integrator Σ) the individual optimized spending amounts. An over budget test (see decision 180) is performed, and when the aggregate spending amount 182 (e.g. the output of the integrator Σ) is less than or equal to the multiple campaign spending limit amount 131, then the system commences bidding (e.g. using the bid preparation unit 135) in order to spend the respective optimized spending amounts (e.g. optimized individual campaign spend 129₁, optimized individual campaign spend 129₂, optimized individual campaign spend 129_{N}, etc.). However, when the aggregate spending amount 182 is greater than the multiple campaign spending limit amount 131, then an individual campaign apportioner 130 serves to apportion the multiple campaign spending limit amount to the constituent member advertising campaigns. The apportioned campaign spend for each campaign is recast as a temporarily-reduced spending limit and is prepared (e.g. by possibly using an individual campaign budget override unit 132) as a temporary override value, and sent to the individual campaign optimizer module 120 (see re-optimization data path 145), which in turn serves to use the reduced spending limits for each individual campaign (e.g. reduced spending limit 133₁, reduced spending limit 133₂, reduced spending limit 133_{N}, etc.) to calculate an optimized spending amount in each of the constituent member advertising campaigns. The flow continues, as earlier described, however this time, the decision 180 (the over budget test) will take the “No” branch, and the flow exits by returning a set of bids corresponding to the respective individual campaigns (see line 8 of Algorithm 1).

The description of the algorithm to generate bid policies includes the aspect of the re-optimization data path 145 in line 7 of Algorithm 1.

FIG. 2 depicts an environment for optimizing bidding with multiple campaign types. As an option, the present environment 200 may be implemented in the context of the architecture and functionality of the embodiments described herein.

FIG. 2 shows an ad network environment including a campaign management module 212 in which some embodiments may operate. In the context of internet advertising, placement of advertisements within web pages has become common. An internet advertiser or agent may select a particular property (e.g. Yahoo.com, www.disney.com, etc.), and host such content in a base content server 207, and an additional content server 208 may generate an advertisement such that whenever any internet user, via a client system 205 (e.g. a client device as further described herein), renders a web page from the selected property, the advertisement (e.g. a creative) is composited on the web page by one or more servers (e.g. base content server 207, search engine server 206, and/or an additional content server 208). The base content and advertisement is packaged for delivery to a client system 205 over a network 202. Given this generalized delivery model, and using techniques disclosed herein, internet advertising might be practiced, and ad traffic can occur between a client system 205 and any other server over a network 202.

Again referring to FIG. 2, an internet property (e.g. a publisher hosting the publisher's base content on a base content server 207) might be able to display an advertisement (e.g. aided by an advertisement serving module 218), and then measure the characteristics of visitors (which visitors may have any arbitrary interest, demographic, target predicates, or other attributes) possibly using an additional content server 208 in conjunction with a historical dataset 220 as pertains to observed users. Thus, an internet user's interests, demographics, target predicates, and/or other attributes might be known in quite some detail, and a campaign forecast generation module 222 might forecast a future supply of impressions that accord to the demographics, target predicates, and/or other attributes. More specifically, a user's clicks (e.g. the likelihood of a click on an ad, or the likelihood of a user action based on an ad) or other responses to an internet advertisement might also be known in quite some detail, not only for a particular user, but also for a group of users corresponding to a particular subset of the available data, and a campaign forecast generation module might use such a particular subset of the available data for forecasting a future supply of impressions where the forecast of a future supply of impressions is organized into groups, the members of the groups being impressions satisfying a particular target predicate. For example, a future supply of impressions may be organized into groups corresponding to a demographic of interest to an advertiser (e.g. “(GENDER=male && AGE=21)”). By definition, a forecasted supply of impressions 214 may comprise one or more instances of a forecasted impression 315.

A campaign parameter tuning module 211 might use any such available data for operations for campaign parameter tuning. A performance-driven advertising campaign parameter may include performance metrics 216. By definition, performance metrics 216 may comprise one or more instances of a performance metric 317.

The aforementioned bids are provided to an advertisement bidding module 209, and bids are submitted to an auction engine server 204. When a bid wins at auction for the opportunity to present an advertisement in an impression, then an advertisement serving module 218 composites the ad in real-time.

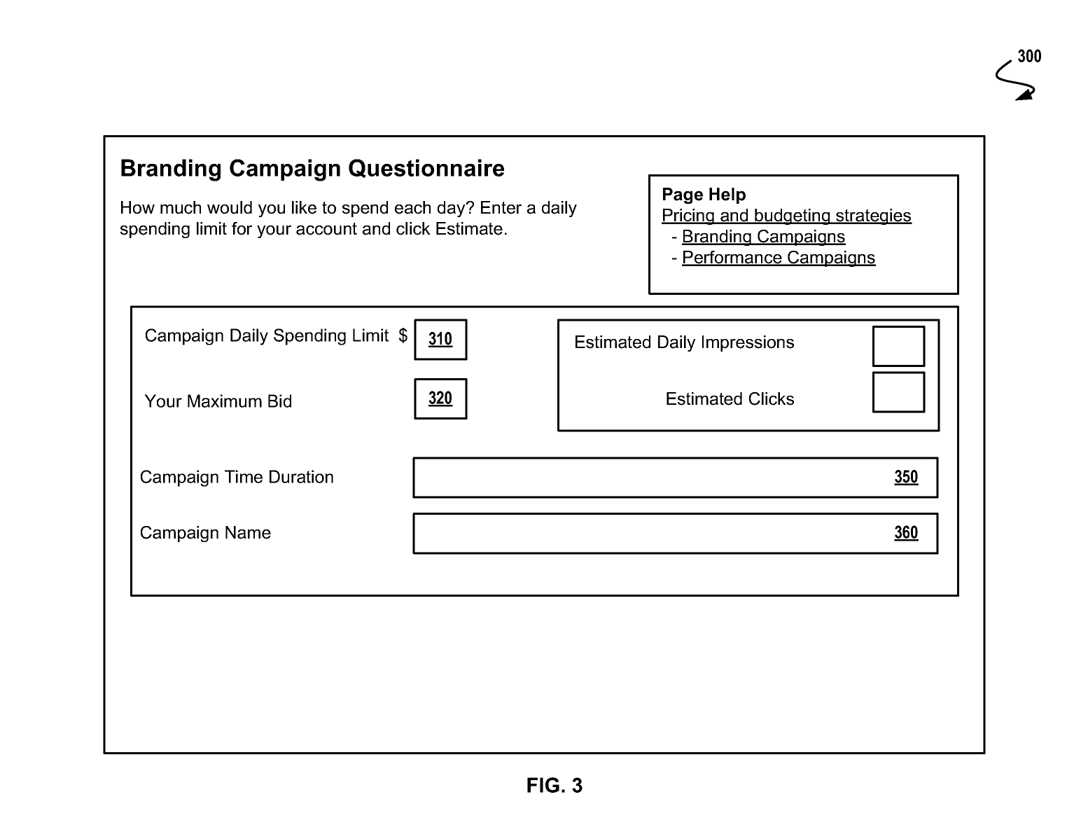

FIG. 3 depicts a form for optimizing bidding in a branding campaign. As an option, the present form 300 may be implemented in the context of the architecture and functionality of the embodiments described herein. Of course, however, the form 300 or any operation therein may be carried out in any desired environment.

FIG. 3 is a form 300 for collecting information regarding a branding campaign, according to one embodiment. As shown, the form for collecting information regarding a branding campaign seeks to guide an advertiser through a series of questions for defining campaign objectives and constraints. Strictly as examples, the “Campaign Daily Spending Limit” question and value 310, serves to collect information about an advertiser's spending limit. The “Your Maximum Bid” question and value 320 serves to collect information about the advertiser's maximum bid constraint. The “Campaign Time Duration” question and value 350 serves to collect information about a campaign time duration. The “Campaign Name” question and value 360 serves to collect information about the advertiser's individual campaign name.

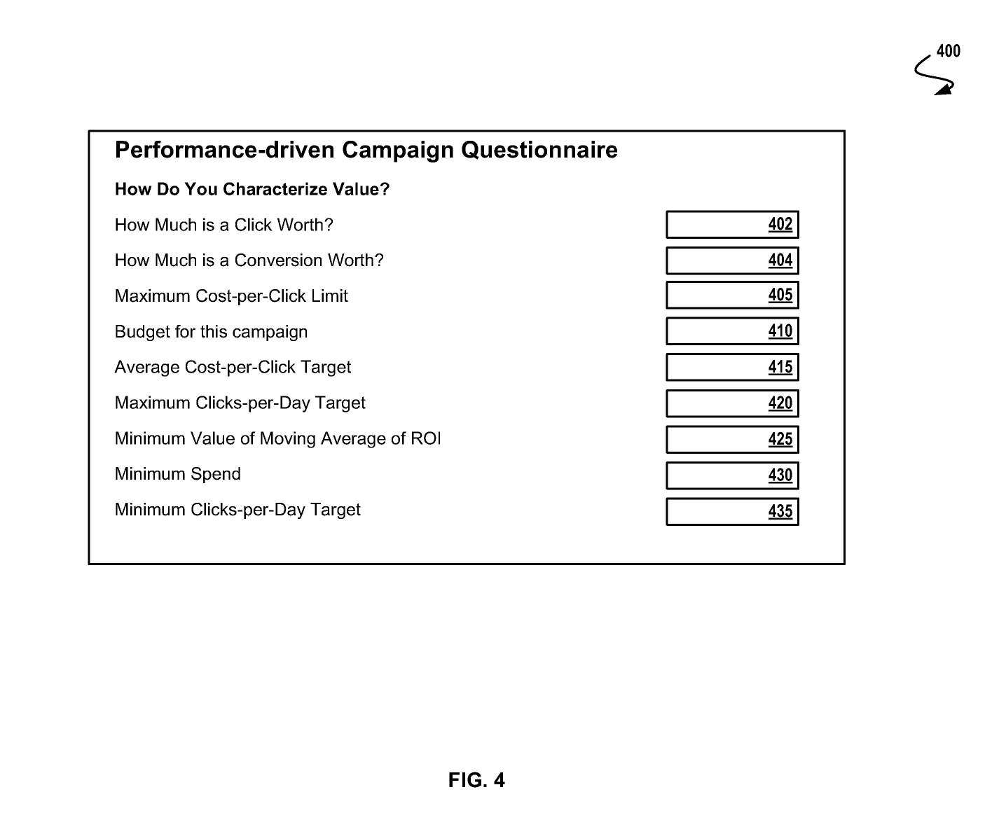

FIG. 4 depicts a form for optimizing bidding in a performance-driven campaign. As an option, the present form 400 may be implemented in the context of the architecture and functionality of the embodiments described herein. Of course, however, the form 400 or any operation therein may be carried out in any desired environment.

FIG. 4 is a form for collecting information regarding objectives and constraints within a performance-driven advertising campaign, according to one embodiment. As shown, the form for collecting information regarding objectives and constraints includes an area for defining how much a click is worth 402, an area for defining how much a conversion is worth 404, an area for defining a maximum cost-per-click limit 405, an area for defining total budget for this campaign 410, an area for defining a target average cost-per-click 415, an area for defining a maximum clicks-per-day 420, an area for defining a minimum value of a moving average of ROI 425, an area for defining a minimum spend 430, and an area for defining a minimum clicks-per-day limit 435.

In various embodiments, advertising is placed by a variety of different types of advertisers (e.g. large advertisers, small advertisers, advertisers seeking brand advertising, advertisers seeking conversions, etc.), where each type of advertiser is holding interests in a variety of campaign objectives and constraints. Therefore, embodiments allow advertisers to express a diverse set of objectives/constraints (e.g. using the form for collecting information regarding objectives and constraints). At the same time, the interface (e.g. form, screen device, etc.) of such an embodiment might be sufficiently rich so as to assist the advertiser toward expressing only the most economically sensible constraints. Moreover, the interface (e.g. form, screen device, etc.) of such an embodiment might be sufficiently rich so as to show estimated the impact of various settings and/or changes in the campaign objectives and constraints.

Of course, there exists a wide range of possible campaign objectives and constraints. Strictly as an example, an objective function for an advertiser's advertising campaign might be a net utility value, expressed as the sum of the values of clicks received during some time period minus the cost of operating the campaign over that same time period. Another objective function for an advertiser's advertising campaign might comprise a return on investment value (ROI, also known as the return on advertising spend—ROAS). ROI is equal to the total value received divided by the cost. For example, the combination of this objective function with a minimum spend constraint might be useful for advertisers who only know their advertising budget as well as the relative (and not the absolute) value of a click from each keyword.

In addition to the above, any one of the constraints described below might be used within a calculation of the objective function of the optimization calculations (e.g. the calculation using an optimization function). For example, an advertiser might try to maximize the number of clicks received subject to the maximum cost-per-click constraints.

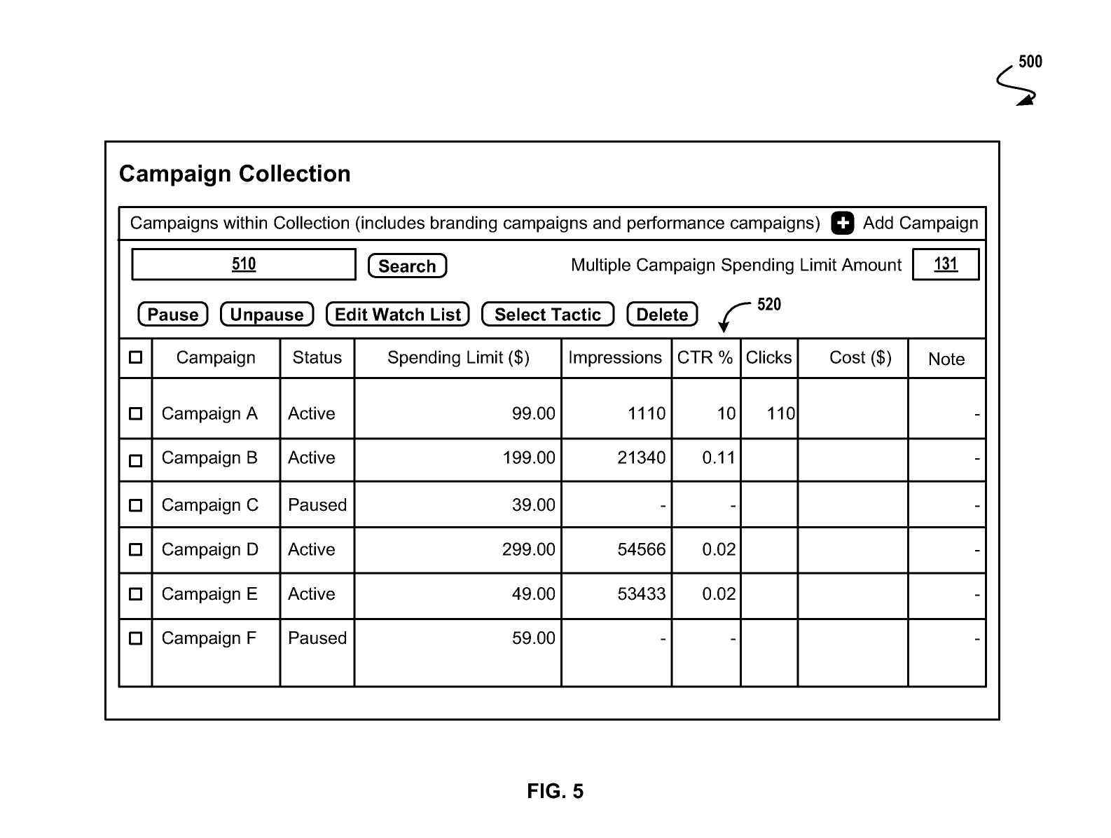

FIG. 5 depicts a form for optimizing bidding with multiple campaign types. As an option, the present form 500 may be implemented in the context of the architecture and functionality of the embodiments described herein. Of course, however, the form 500 or any operation therein may be carried out in any desired environment.

FIG. 5 is a form for displaying information regarding a plurality of advertising campaigns, according to one embodiment. As shown, the form for displaying information regarding a plurality of advertising campaigns serves to display information about any number of campaigns. In some cases, an advertiser might prosecute a large number of different campaigns. Accordingly, a mechanism for quickly displaying information regarding a plurality of advertising campaigns is provided, including a campaign search box 510 and including a table for displaying campaign information 520. The form might allow the advertiser to organize campaigns into any number of searchable, concurrently running (or paused) campaigns or sub-campaigns. Any given campaigns or sub-campaigns might be associated with a corresponding set of constraints selected from any one or more of the above campaign objectives and constraints. The form provides an entry field for a multiple campaign spending limit amount 131, and as detailed herein, the aggregate spending across all of the collection of individual campaigns is compared with the multiple campaign spending limit amount 131.

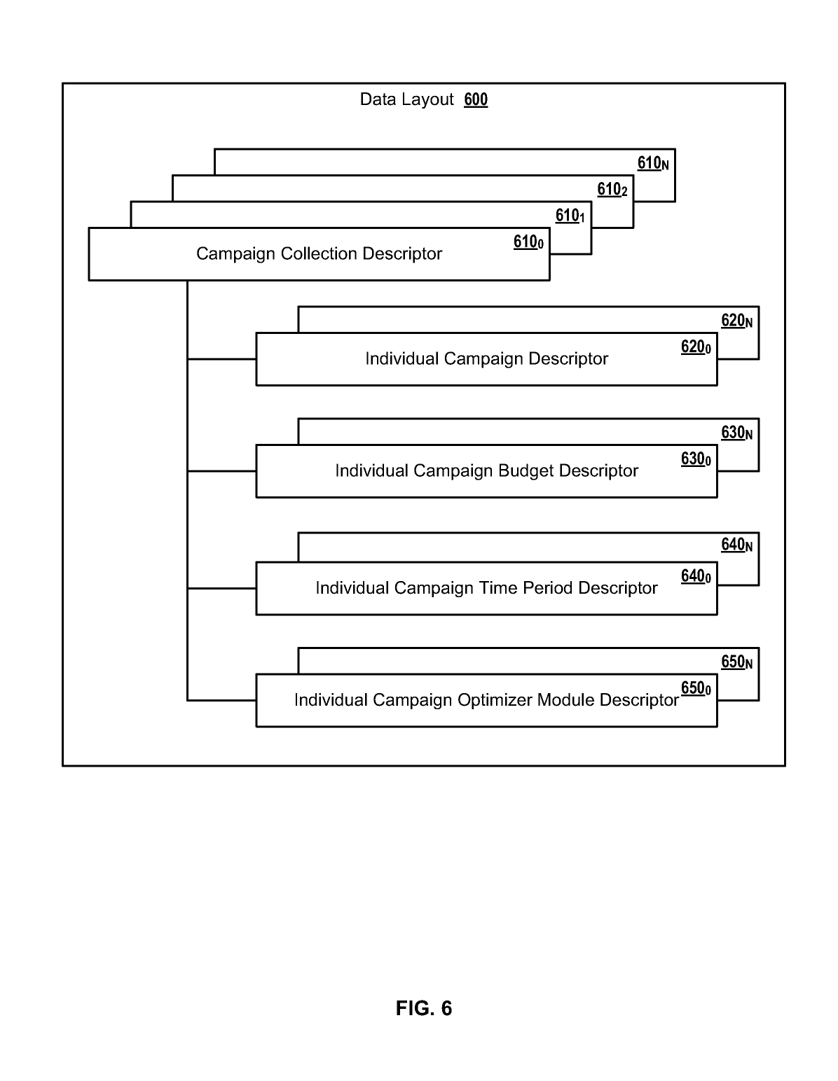

FIG. 6 depicts a data layout for optimizing bidding with multiple campaign types. As an option, the present data layout 600 may be implemented in the context of the architecture and functionality of the embodiments described herein. Of course, however, the data layout 600 or any operation therein may be carried out in any desired environment.

As shown, the data layout might comprise any one or more campaign collection descriptors (e.g. campaign collection descriptor 610₀, campaign collection descriptor 610₁, campaign collection descriptor 610₂, campaign collection descriptor 610_{N}, etc.) which in turn comprises one or more individual campaign descriptors (e.g. individual campaign descriptor 620₀, individual campaign descriptor 620_{N}, etc.), one or more individual campaign budget descriptors (e.g. individual campaign budget descriptor 630₀, individual campaign budget descriptor 630_{N}, etc.), one or more individual campaign time period descriptors (e.g. individual campaign time period descriptor 640₀, individual campaign time period descriptor 640_{N}, etc.), and any one or more individual campaign optimizer module descriptors (e.g. individual campaign optimizer module descriptor 650₀, individual campaign optimizer module descriptor 650_{N}, etc.).

The values stored in any descriptor might be provided to modules as described above. For example, the value stored in individual campaign time period descriptor 640_{N} might be provided to the individual campaign optimizer 126_{N}. In some embodiments, an individual campaign optimizer module descriptor describes advertiser-specified importance of one individual campaign or another (e.g. importance of an ROI campaign versus the importance of a search-term campaign, etc.).

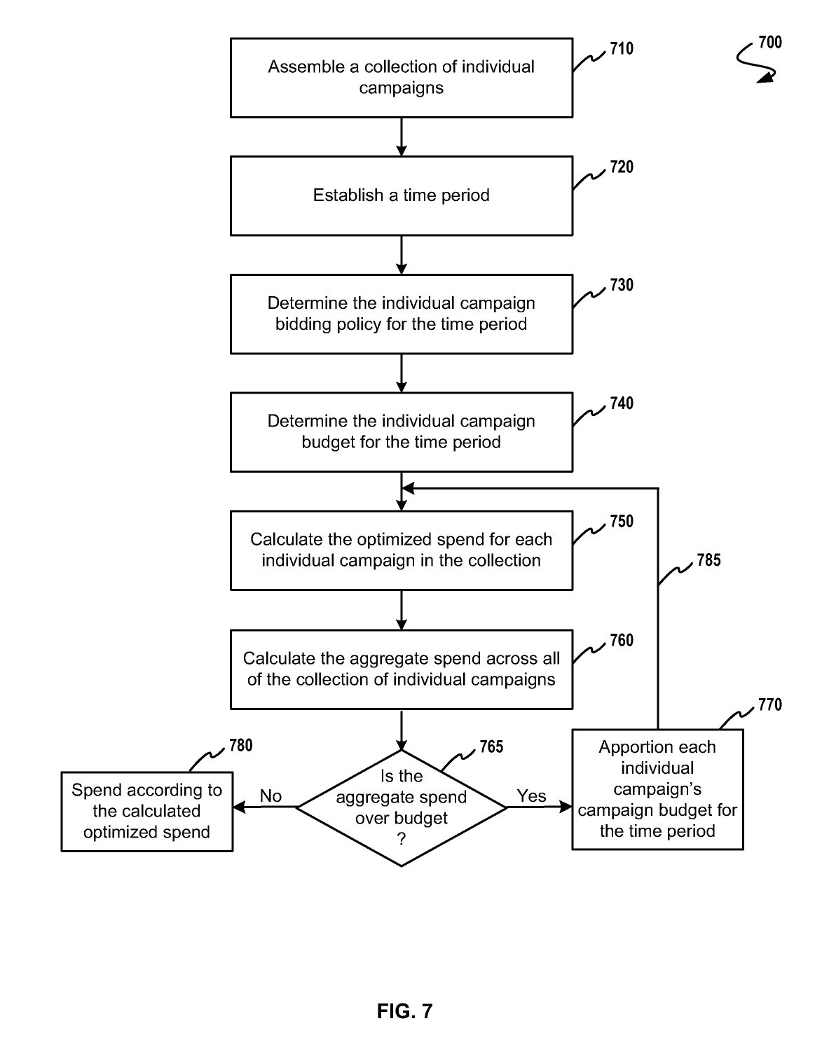

FIG. 7 depicts a flow chart for optimizing bidding with multiple campaign types. As an option, the present flow chart 700 may be implemented in the context of the architecture and functionality of the embodiments described herein. Of course, however, the algorithm of the present flow chart 700 or any operation therein may be carried out in any desired environment.

As shown, the flow chart 700 commences by assembling a collection individual campaigns (see operation 710), and establishing a time period for optimization (see operation 720). Optimization might be performed in arbitrarily small time slices. For example, if a daily spending limit were established at say one thousand dollars, the daily spending limit could be broken down into smaller amounts, corresponding to the smaller time slices. In a linear break-down, a one thousand dollar daily limit could be broken down into say ten hours per day, the ten hours corresponding to the core hours (e.g. 7am-5 pm) in that time zone, and each of those ten hours could have a budget of one hundred dollars. Continuing, each individual campaign might have its own campaign bidding policy (and again refer to the aforementioned forms of FIG. 3 through FIG. 5). A bidding policy might be associated with a time period (see operation 730). Similarly each individual campaign might have its own campaign budget. And, a campaign budget might be associated with a time period (see operation 740).

In operation, an optimized amount to spend for each individual campaign is calculated (see operation 750), and the aggregate spending across all of the collection of individual campaigns is calculated (see operation 760). In some embodiments, the aggregate spending across all of the collection of individual campaigns is compared with the multiple campaign spending limit amount 131. If the aggregate spend is not over budget (see decision 765), then spend according to the optimized spend for each individual campaign in the collection (see operation 780). On the other hand, if the aggregate spend is over budget (see decision 765), then apportion each individual campaign's campaign budget for the time period see operation 770), and re-optimize (see re-optimization flow path 785).

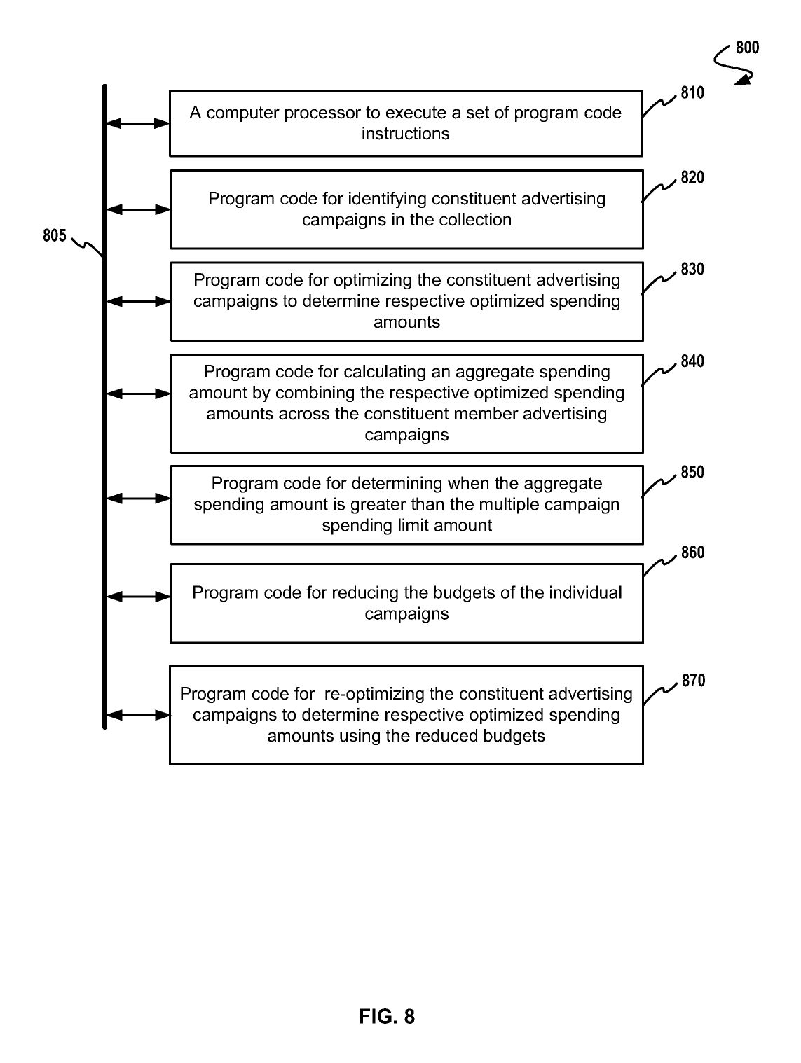

FIG. 8 depicts a block diagram of a system to perform certain functions of a computer system. As an option, the present system 800 may be implemented in the context of the architecture and functionality of the embodiments described herein. Of course, however, the system 800 or any operation therein may be carried out in any desired environment. As shown, system 800 comprises at least one processor and at least one memory, the memory serving to store program instructions corresponding to the operations of the system. As shown, an operation can be implemented in whole or in part using program instructions accessible by a module. The modules are connected to a communication path 805, and any operation can communicate with other operations over communication path 805. The modules of the system can, individually or in combination, perform method operations within system 800. Any operations performed within system 800 may be performed in any order unless as may be specified in the claims. The embodiment of FIG. 8 implements a portion of a computer system, shown as system 800, comprising a computer processor to execute a set of program code instructions (see module 810) and modules for accessing memory to hold program code instructions to perform: identifying constituent advertising campaigns in the collection (see module 820); optimizing the constituent advertising campaigns to determine respective optimized spending amounts (see module 830); calculating an aggregate spending amount by combining the respective optimized spending amounts across the constituent member advertising campaigns (see module 840); determining when the aggregate spending amount is greater than the multiple campaign spending limit amount (see module 850); reducing the budgets of the individual campaigns (see module 860); and re-optimizing the constituent advertising campaigns to determine respective optimized spending amounts using the reduced budgets (see module 870).

### Section III: Exemplary Practice of Embodiments

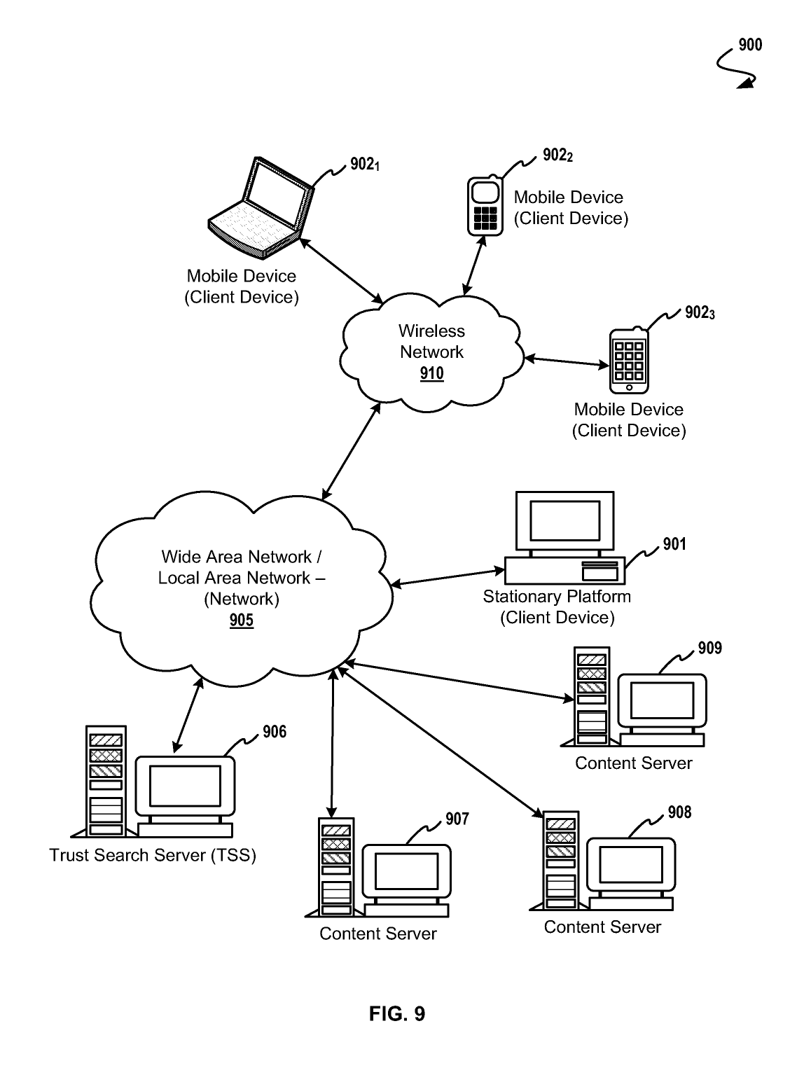

FIG. 9 depicts a schematic diagram 900 illustrating an example embodiment of an advertising network for optimizing bidding with multiple campaign types.

Other embodiments that may vary, for example, in terms of arrangement or in terms of type of components, are also intended to be included within the claimed subject matter. As shown, FIG. 9, for example, includes a variety of networks, such as a local area local area network (LAN)/wide area network (WAN) 905 and wireless network 910; a variety of devices, such as client devices such as a stationary platform 901, a mobile device 902₁, a mobile device 902₂, a mobile device 902₃ and a variety of servers, such as a local content server 907, such as a remote content server 908, such as a cloud-based content server 909, and such as a search server 906.

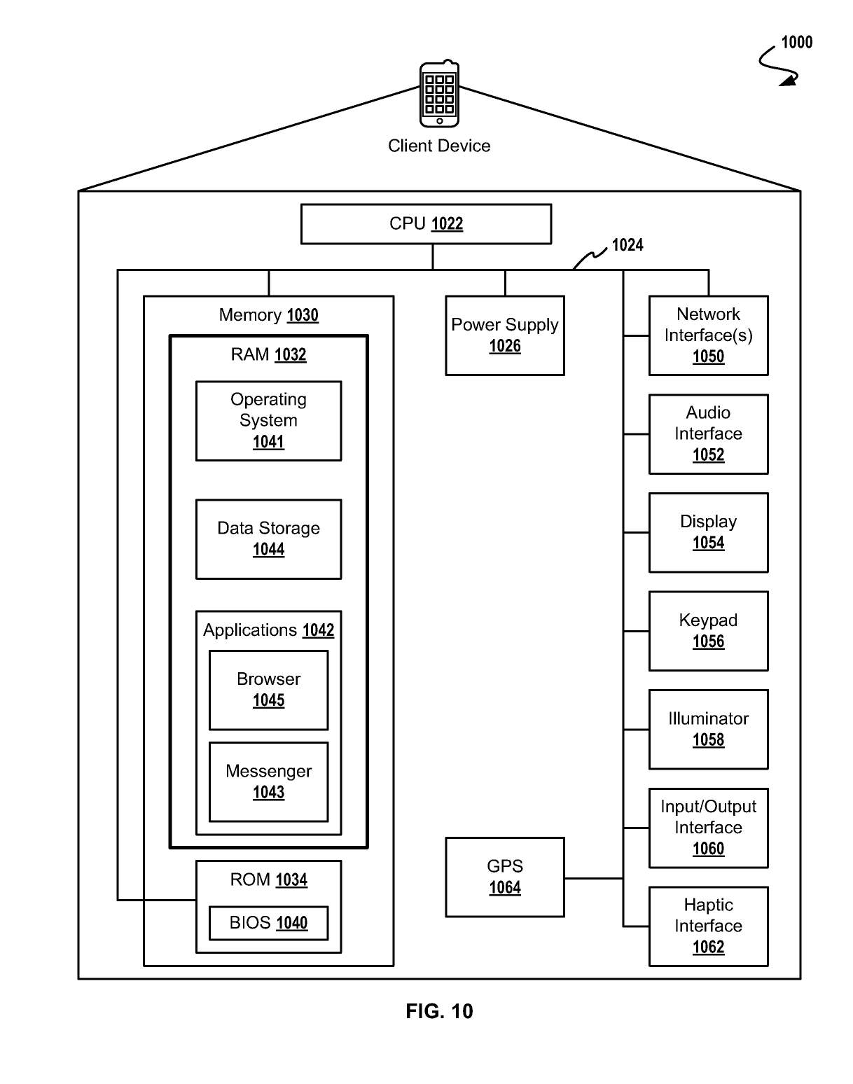

FIG. 10 depicts a schematic diagram illustrating an example embodiment of a client device. A client device 1000 may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device, a personal digital assistant (PDA), a handheld computer, a tablet computer, a laptop computer, a set top box, a wearable computer, an integrated device combining various features, such as features of the forgoing devices, or the like.

A client device may vary in terms of capabilities or features. Claimed subject matter is intended to cover a wide range of potential variations. For example, a cell phone may include a numeric or other instance of a keypad 1056 or a display 1054 of limited functionality, such as a monochrome liquid crystal display (LCD) for displaying text and symbols. In contrast, however, as another example, a web-enabled client device may include one or more physical or virtual keyboards, mass storage, one or more accelerometers, one or more gyroscopes, a global positioning system (e.g. GPS 1064) or other location-identifying type capability, or a display with a high degree of functionality, such as a touch-sensitive color 2D or 3D display, possibly with backlighting or other illuminator 1058, or a haptic interface 1062, or another variety of input/output interface 1060, for example.

A client device may include memory 1030, possibly with a section of RAM 1032 or other memory (e.g. data storage 1044) or forms of non-volatile memory (e.g. ROM 1034) that can be accessed by a processor (e.g. CPU 1022) and which may execute a variety of basic I/O functions (e.g. BOS 1040) and/or may execute a variety operating systems 1041, including a personal computer operating system such as a Windows, iOS, or Linux, or a mobile operating system such as iOS, Android, or Windows Mobile, or the like. A client device may include or may execute a variety of possible applications 1042, such as a client software application enabling communication with other devices, such as communicating one or more messages using a messenger application 1043, or such as via email, short message service (SMS), or multimedia message service (MMS), including via a network such as a social network including, for example, Facebook, LinkedIn, Twitter, Flickr, or Google+, to provide only a few possible examples. A client device may also include or execute an application to communicate content, such as, for example, textual content, multimedia content, or the like. A client device may also include or execute an application to perform a variety of possible tasks, such as browsing using a browser 1045, searching, playing various forms of content, including locally stored or streamed video, audio (e.g. using audio interface 1052) or games (such as fantasy sports leagues), possibly including networked games or other applications using one or more instances of network interface 1050. Any of the foregoing functional blocks comprising the client device 1000 can be powered by one or more instances of power supply 1026, and any of the foregoing functional blocks comprising the client device 1000 can communicate with any other of the foregoing functional blocks over a communication bus 1024. The foregoing is provided to illustrate that claimed subject matter is intended to include a wide range of possible features or capabilities.

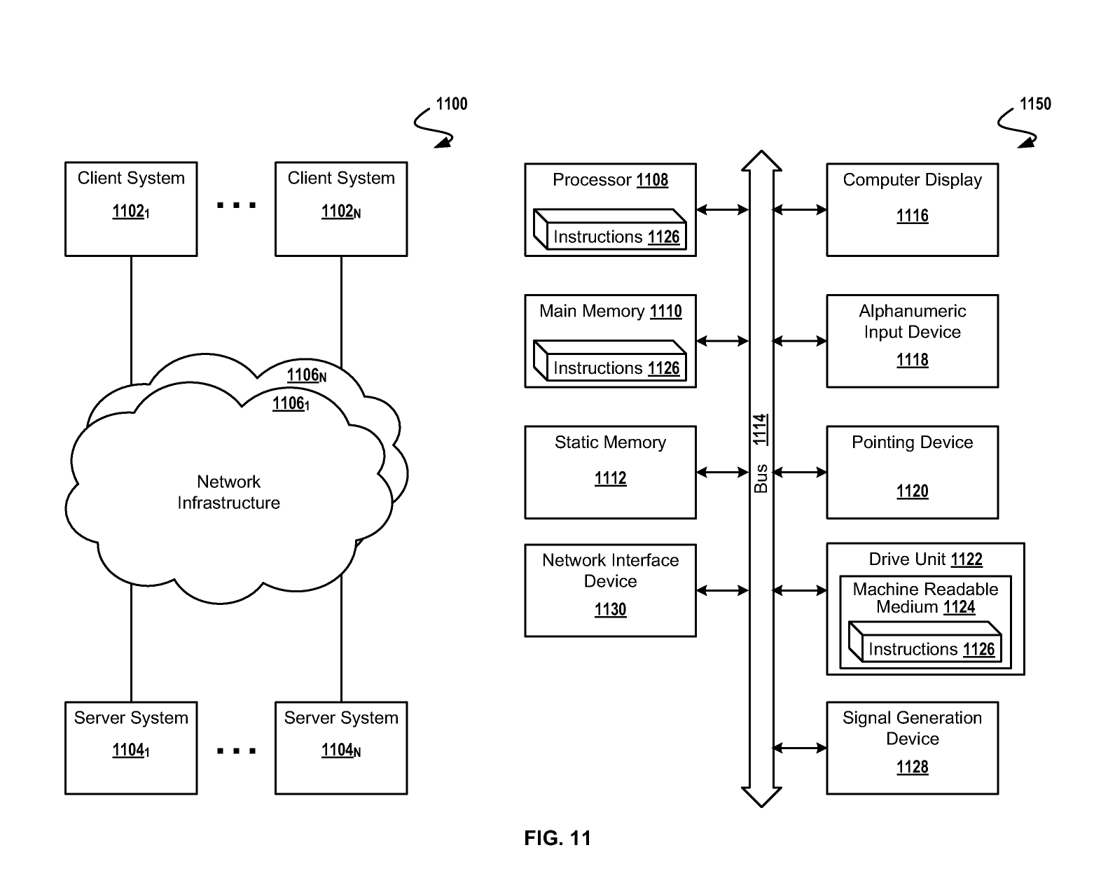

FIG. 11 is a block diagram 1100 of a computer system for implementing embodiments. The computer system includes nodes for client computer systems 1102₁ through 1102_{N}, nodes for server computer systems 1104₁ through 1104_{N}, and nodes for network infrastructure 1106₁ through 1106_{N}, any of which nodes may comprise a machine (e.g. computer 1150) within which a set of instructions for causing the machine to perform any one of the techniques discussed above may be executed. The embodiment shown is purely exemplary, and might be implemented in the context of one or more of the figures herein.

Any node of the network may comprise a general-purpose processor, a digital signal processor (DSP), an application specific integrated circuit (ASIC), a field programmable gate array (FPGA) or other programmable logic device, a discrete gate or transistor logic, discrete hardware components, or any combination thereof capable to perform the functions described herein. A general-purpose processor may be a microprocessor, but in the alternative, the processor may be any conventional processor, controller, microcontroller, or state machine. A processor may also be implemented as a combination of computing devices (e.g. a combination of a DSP and a microprocessor, a plurality of microprocessors, one or more microprocessors in conjunction with a DSP core, or any other such configuration, etc.).

In alternative embodiments, a node may comprise a machine in the form of a virtual machine (VM), a virtual server, a virtual client, a virtual desktop, a virtual volume, a network router, a network switch, a network bridge, a personal digital assistant (PDA), a cellular telephone, a web appliance, or any machine capable of executing a sequence of instructions that specify actions to be taken by that machine. Any node of the network may communicate cooperatively with another node on the network. In some embodiments, any node of the network may communicate cooperatively with every other node of the network. Further, any node or group of nodes on the network may comprise one or more computer systems (e.g. a client computer system, a server computer system) and/or may comprise one or more embedded computer systems (including a processor and memory), a massively parallel computer system, and/or a cloud computer system.

The computer system (e.g. computer 1150) includes a processor 1108 (e.g. a processor core, a microprocessor, a computing device, etc.), a main memory (e.g. computer memory 1110), and a static memory 1112, which communicate with each other via a system bus 1114. The computer 1150 may further include a display unit (e.g. computer display 1116) that may comprise a touch-screen, or a liquid crystal display (LCD), or a light emitting diode (LED) display, or a cathode ray tube (CRT). As shown, the computer system also includes a human input/output (I/O) device 1118 (e.g. a keyboard, an alphanumeric keypad, etc.), a pointing device 1120 (e.g. a mouse, a touch screen, etc.), a drive unit 1122 (e.g. a disk drive unit, a CD/DVD drive, a tangible computer readable removable media drive, an SSD storage device, etc.), a signal generation device 1128 (e.g. a speaker, an audio output, etc.), and a network interface device 1130 (e.g. an Ethernet interface, a wired network interface, a wireless network interface, a propagated signal interface, etc.).

The drive unit 1122 includes a machine-readable medium 1124 on which is stored a set of instructions (i.e. software, firmware, middleware, etc.) 1126 embodying any one, or all, of the methodologies described above. The set of instructions 1126 is also shown to reside, completely or at least partially, within the main memory and/or within the processor 1108. The set of instructions 1126 may further be transmitted or received via the network interface device 1130 over the system bus 1114.

It is to be understood that embodiments of this disclosure may be used as, or to support, a set of instructions executed upon some form of processing core (such as the CPU of a computer) or otherwise implemented or realized upon or within a machine- or computer-readable medium. A machine-readable medium includes any mechanism for storing non-transitory information in a form readable by a machine (e.g. a computer). For example, a machine-readable medium includes read-only memory (ROM); random access memory (RAM); magnetic disk storage media; optical storage media; flash memory devices; and electrical, optical or acoustical or any other type of media suitable for storing non-transitory information.

While the figures and description have been described with reference to numerous specific details, one of ordinary skill in the art will recognize that the claimed embodiments can be differently embodied in other specific forms without departing from the scope of the claims.

We claim:

1. A computer implemented method for optimizing bidding for a collection of multiple advertising campaigns having a least two campaign types under a constraint of a multiple campaign spending limit amount, the method comprising:
identifying constituent advertising campaigns in the collection;
optimizing the constituent advertising campaigns to determine respective optimized spending amounts;
calculating an aggregate spending amount by combining the respective optimized spending amounts across the constituent member advertising campaigns;
determining when the aggregate spending amount is greater than the multiple campaign spending limit amount, then;
reducing the budgets of the individual campaigns; and
re-optimizing the constituent advertising campaigns to determine respective optimized spending amounts using the reduced budgets.

2. The method of claim 1, wherein the constituent member advertising campaign comprises at least a respective optimization function and a respective spending limit amount.

3. The method of claim 1, wherein the two campaign types comprise a branding campaign and a performance-driven campaign.

4. The method of claim 1, wherein calculating the aggregate spending amount comprises calculating the sum of the respective optimized spending amounts.

5. The method of claim 1, wherein reducing the budgets of the individual campaigns comprises a non-linear apportioning.

6. The method of claim 1, wherein reducing the budgets of the individual campaigns comprises apportioning based on advertiser-specified importance of one campaign or another.

7. The method of claim 1, further comprising returning a set of bids corresponding to the respective individual campaigns.

8. A computer system for optimizing bidding with multiple campaign types, comprising:
a computer processor to execute a set of program code instructions; and
a memory to hold the program code instructions, in which the program code instructions comprises program code to perform,
identifying constituent advertising campaigns in the collection;
optimizing the constituent advertising campaigns to determine respective optimized spending amounts;
calculating an aggregate spending amount by combining the respective optimized spending amounts across the constituent member advertising campaigns;
determining when the aggregate spending amount is greater than the multiple campaign spending limit amount, then;
reducing the budgets of the individual campaigns; and
re-optimizing the constituent advertising campaigns to determine respective optimized spending amounts using the reduced budgets.

9. The computer system of claim 8, wherein the constituent member advertising campaign comprises at least a respective optimization function and a respective spending limit amount.

10. The computer system of claim 8, wherein the two campaign types comprise a branding campaign and a performance-driven campaign.

11. The computer system of claim 8, wherein calculating the aggregate spending amount comprises calculating the sum of the respective optimized spending amounts.

12. The computer system of claim 8, wherein reducing the budgets of the individual campaigns comprises a non-linear apportioning.

13. The computer system of claim 8, wherein reducing the budgets of the individual campaigns comprises apportioning based on advertiser-specified importance of one campaign or another.

14. The computer system of claim 8, further comprising returning a set of bids corresponding to the respective individual campaigns.

15. A computer program product embodied in a non-transitory computer readable medium, the computer readable medium having stored thereon a sequence of instructions which, when executed by a processor causes the processor to execute a method to implement optimizing bidding with multiple campaign types, the method comprising:
identifying constituent advertising campaigns in the collection;
optimizing the constituent advertising campaigns to determine respective optimized spending amounts;
calculating an aggregate spending amount by combining the respective optimized spending amounts across the constituent member advertising campaigns;
determining when the aggregate spending amount is greater than the multiple campaign spending limit amount, then;
reducing the budgets of the individual campaigns; and
re-optimizing the constituent advertising campaigns to determine respective optimized spending amounts using the reduced budgets.

16. The computer program product of claim 15, wherein the constituent member advertising campaign comprises at least a respective optimization function and a respective spending limit amount.

17. The computer program product of claim 15, wherein the two campaign types comprise a branding campaign and a performance-driven campaign.

18. The computer program product of claim 15, wherein calculating the aggregate spending amount comprises calculating the sum of the respective optimized spending amounts.

19. The computer program product of claim 15, wherein reducing the budgets of the individual campaigns comprises a non-linear apportioning.

20. The computer program product of claim 15, wherein reducing the budgets of the individual campaigns comprises apportioning based on advertiser-specified importance of one campaign or another.

21. A computer implemented method for optimizing bidding over multiple advertising campaigns having a least two campaign types under a constraint of a multiple campaign spending limit amount, the method comprising:
identifying a collection of the multiple advertising campaigns, a constituent member advertising campaign having at least a respective optimization function and a respective spending limit amount;
evaluating the constituent member advertising campaigns to determine a respective optimized spending amount, the respective optimized spending amount determined using the respective optimization function;
calculating an aggregate spending amount by aggregating the respective optimized spending amount across the constituent member advertising campaigns; and
determining an amount to spend by processing conditions:
when the aggregate spending amount is less than or equal to the multiple campaign spending limit amount, then spending the respective optimized spending amount in the constituent member advertising campaigns;
when the aggregate spending amount is greater than the multiple campaign spending limit amount, then apportioning the multiple campaign spending limit amount to the constituent member advertising campaigns to determine a reduced spending limit used in calculating an optimized spending amount in the constituent member advertising campaigns.
